(19) United States
(12) Patent Application Publication
(10) Pub. No.: US 2015/0326473 A1
(43) Pub. Date: Nov. 12, 2015

(54) Service Chain Path Route Reservations

(71) Applicant: Futurewei Technologies, Inc., Plano, TX (US)

(72) Inventors: Linda Dunbar, Plano, TX (US); Young Lee, Plano, TX (US); Andrew G. Malis, Andover, MA (US)

(21) Appl. No.: 14/708,104

(22) Filed: May 8, 2015

Related U.S. Application Data
(60) Provisional application No. 61/991,002, filed on May 9, 2014.

(51) Int. Cl. H04L 12/723; H04L 12/721; H04L 12/705

(52) U.S. Cl. CPC H04L 45/50; H04L 45/18; H04L 45/566

(57) ABSTRACT

An apparatus comprising an ingress port, an egress port, a port associated with a service function, a memory, and a processor coupled to the ingress port, the egress port, the port, and the memory, and configured to receive from the ingress port a data packet that comprises a packet header that is associated with a service identifier (ID), forward the data packet to the port for processing by the service function, receive the data packet from the port in response to forwarding the data packet to the port, and forward the data packet to the egress port to a network node.

### CROSS-REFERENCE TO RELATED APPLICATIONS

The present application claims priority to U.S. Provisional Application No. 61/991,002 filed May 9, 2014 by Linda Dunbar, et al., and entitled “Service Chain Instance Path Route Reservations,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The delivery of end-to-end services often requires various service functions to be performed on data packets. Data packets are forwarded through a network along service function paths to be processed by one or more service functions. Multiprotocol label switching (MPLS) allows network nodes in a network to direct data packets from one network node to the next network node based on short path labels rather than long network addresses. The labels identify paths (e.g., virtual links) between adjacent network nodes rather than end points (e.g., a source network node and a destination network node). In MPLS, data packets from a path computation engine (PCE) do not come back once they leave a forwarding network node. Using existing systems, routing loop problems occur when a data packet returns to the forwarding network node once it has been sent by the network node. Routing loops can negatively impact a network's performance by consuming network resources such as processing power and bandwidth. Typically, routing loops are undesirable and are avoided using existing systems.

### SUMMARY

In one embodiment, the disclosure includes a data packet forwarding method comprising receiving at a first port a data packet that comprises at least one packet header that is associated with a service chain identifier (ID), forwarding the data packet to at least one second port to be processed by at least one service function, receiving the data packet from the at least one second port in response to forwarding the data packet to the at least one second port, and forwarding the data packet to a third port to a network node.

In another embodiment, the disclosure includes a data packet routing method comprising receiving service function path information that identifies a service function path, generating a path reservation message that comprises at least a portion of the service function path information, sending the path reservation message to a network node along the service function path, and receiving a confirmation message in response to the path reservation message.

In yet another embodiment, the disclosure includes an apparatus comprising an ingress port, an egress port, a port associated with a service function, a memory, and a processor coupled to the ingress port, the egress port, the port, and the memory, and configured to receive from the ingress port a data packet that comprises a packet header that is associated with a service ID, forward the data packet to the port for processing by the service function, receive the data packet from the port in response to forwarding the data packet to the port, and forward the data packet to the egress port to a network node.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a system for routing data packets to service functions along service function paths.

FIG. 2 is an embodiment of a service function chain.

FIG. 3 is a schematic diagram of an embodiment of a network element.

FIG. 4 is a schematic diagram of an embodiment of a portion of a network implementing service function instance forwarding.

FIG. 5 is an embodiment of a service function path entry.

FIG. 6 is an embodiment of a steering policy for forwarding data packets along a service function path.

FIG. 7 is a schematic diagram of an embodiment of a portion of a network implementing service function forwarding across multiple network layers.

FIG. 8 is an embodiment of a steering policy for forwarding data packets along a service function path and across multiple network layers.

FIG. 9 is an embodiment of a local forwarding policy for routing data packets within a network node.

FIG. 10 is a flowchart of an embodiment of a service function instance forwarding method.

FIG. 11 is a schematic diagram of an embodiment of service function explicit routing object sub-type-length-value.

FIG. 12 is a flowchart of another embodiment of a service function instance forwarding method.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are various embodiments for routing and implementing service functions along service function chains and service function paths. Network nodes are configured to route and forward data packets along different service function paths and forwarding paths based on service function path information. Network nodes are configured to generate service function path entries based on the service function path information, to generate steering policies based on the service function path information, and to generate local or internal forwarding policies. Service function path entries, steering policies, and local steering policies can be employed to route data packets using based on both the network nodes and the service function along a service function chain. This provides two layers of routing ability for data packets. Further, network nodes are configured to send a data packet from a port to a service function and then to receive the processed data packet from the same port after the service function processes the data packet without causing looping problems. As such, routing loops can be implemented in a network for routing data packets along service function chains or service function paths.

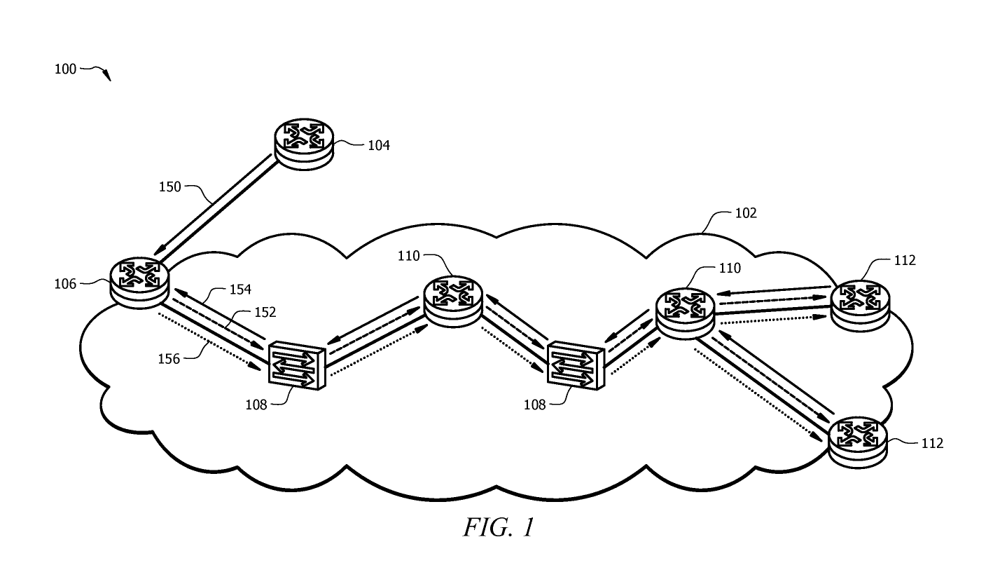

FIG. 1 is a schematic diagram of an embodiment of a system 100 configured to route data packets to service functions along service function chains or service function paths and process data packets using service functions. System 100 comprises a service chain path compute engine (SC-PCE) 104 and a network 102 that comprises network nodes 106-112. System 100 may be configured as shown or in any other suitable configuration. For example, system 100 may comprise any number of network nodes 106-112.

SC-PCE 104 is configured to compute and provide service function chains and service function paths for network 102. A service function chain is an ordered set of service functions and ordering constraints that is applied to data packets, data frames, and/or data flows. A service function chain may comprise one or more service function paths along the service function chain. A service function path may also be referred to as an explicit path. A service function is a function that specifies a specific treatment for a data packet. Service functions are functions that can act at various layers of a protocol stack, for example, at the network layer or other open system interconnection (OSI) layers. A service function can be realized as a virtual element, a physical network element, or embedded in a physical network element. One or more service functions can be embedded in the same network element. Multiple occurrences or instances of the service function can exist in the same domain. A service function may also be referred to as a service function instance when multiple instances exist. As such, the terms “service function” and “service function instance” may be used interchangeably. Examples of service functions include, but are not limited to, firewalls, wide area network (WAN) and application acceleration, deep packet inspection (DPI), lawful interception (LI), server load balancing, network address translation (NAT)-44, NAT-64, Internet Protocol version 6 network prefix translation (NPTv6), HOST_ID injection, hypertext transfer protocol (HTTP) header enrichment functions, and transmission control protocol (TCP) optimization.

Network node 106 is configured as a service function chain or service function path ingress node. A service function path ingress node may also be referred to as a head-end of the service function path. Network nodes 108 are service function forwarder (SFF) network nodes that comprise a plurality of ports and one or more service functions attached to each of the ports. A port that is attached to a service function refers to a port of an SFF network node that is physically coupled to a service function, configured to be couple to a service function, associated with a service function, or configured to interact with a service function. SFF network nodes are configured to forward data packets to the attached service functions and to other network nodes. An SFF network node is configured to discover which port each service function is connected to. For example, an SFF network node may employ an address resolution protocol (ARP)/neighbor discovery (ND) protocol where the Internet Protocol (IP) address of the service function is attached by an explicit route (ERO) to discover which port each service function is connected to. Network nodes 110 are configured to communicate data packets through network 102. Network nodes 112 are configured as service function chain or service function path egress nodes. A service function path egress node may also be referred to as a tail-end of the service function path. SC-PCE 104 and network nodes 106-112 may be coupled to one another via one or more tunnels and/or links. Examples of tunnels include, but are not limited to, multiprotocol label switching (MPLS) tunnels and virtual extensible local area network (VxLAN) tunnels. Links may include physical links, such as electrical and/or optical links, and/or logical links (e.g., virtual links).

SC-PCE 104 is configured to compute service function chains and service function paths for the service function chain and to send the service function path information 150 to the service function path ingress node (e.g., network node 106). Service function path information 150 can be sent as an individual message or can be carried within a data packet. The service function path information 150 may comprise a service chain identifier (ID), a list of SFF network nodes or SFF network node identifiers along a service function path, a list of service functions attached to each of the SFF network nodes, and an ingress node for the service function path. In an embodiment, SC-PCE 104 sends the service function path information 150 using a PCE communication protocol and path request message or path request message objects as described in Internet Engineering Task Force (IETF) request for comments (RFC) 5440 titled, “Path Computation Element (PCE) Communication Protocol (PCEP),” by Vassuer et al., published in March 2009, which is hereby incorporated by reference as if reproduced in its entirety, or other versions thereof. Alternatively, the service function path information 150 is sent using an explicit signaling method (e.g., head-end dynamic signaling and software-defined networking (SDN) controller dynamic signaling) or an out-of-band provisioning method.

The service function path ingress node, network node 106, is configured to inspect the service function path information 150 and to send a path message 152 that comprises at least a portion of the service function path information 150 to a next hop along the service function path towards the egress node of the service function path. Path message 152 may also be referred to as a path reservation message. The path message 152 is shown as a dashed arrow line. A path message may be configured similarly to path messages described in IETF RFC 4875 titled, “Extensions to Resource Reservation Protocol—Traffic Engineering (RSVP-TE) for Point-to-Multipoint TE Label Switched Paths (LSPs),” by Aggarwal et al., published in May 2007, which is hereby incorporated by reference as if reproduced in its entirety, or other versions thereof. For legacy IP networks, network node 106 is configured to encapsulate the RSVP in VxLAN. For example, network node 106 maps the service chain ID to a VxLAN header. The RSVP sub-TLV carries the list of service function network nodes attached to each service function forwarder network node. Table 1 is an embodiment of encapsulating RSVP in VxLAN.

TABLE 1
An embodiment of encapsulating RSVP in VxLAN

<Path Message> ::= <Common Header> [ <INTEGRITY> ]

<SESSION> <SFF_HOP> <TIME_VALUES>
[ <List_SFF> ]
[ <sender descriptor> ]

<List_SFF> ::= {[<SFF_NODE> {<SF>...}] ...}

Network nodes 108 and 110 are configured to receive the path message 152, to configure itself based on the service function path information 150, and to forward the path message 152 to a next hop along the service function path towards the egress node of the service function path. The service function path information 150 comprises instructions for network nodes 108 and/or 110 to associate or to map a tunnel, a port, and/or one or more data packet attributes to a service chain ID for routing data packets. Data packet attributes may include, but are not limited to, a packet header, a tunnel header, a media access control address, an IP address, a virtual local area network (VLAN) ID, a multiprotocol label switching (MPLS) tag or label, a virtual private network (VPN) header, and a global label. Alternatively, network nodes 108 and 110 may receive instructions for associating or to mapping a tunnel, a port, and/or one or more data packet attributes to a service chain ID for routing data packets in a separate message (not shown) from SC-PCE 104.

The service function egress nodes, network nodes 112, are configured to inspect the service function path information 150 from path message 152 and to send a confirmation message 154 to a previous hop along the service function path towards the ingress node of the service function path. The confirmation message 154 is shown as a solid arrow line. In an embodiment, the confirmation message may be configured similarly to reservation (RESV) messages described in IETF RFC 4875.

Data packets 156 may then be communicated from the service function ingress node along the service function paths to the service function egress nodes when the confirmation message is received by the service function ingress node. Data packets 156 are shown as a starred arrow line.

Additional details about service functions and service function chaining architectures are described in IETF RFC draft titled, “Service Function Chaining (SFC) Architecture,” by J. Halpern, et al., published on Mar. 6, 2015, IETF RFC draft titled, “Service Function Chaining (SFC) Control Plane Achitecture,” by H. Li, et al., published on Mar. 8, 2015, IETF RFC draft titled, “Framework for Service Function Path Control,” by L. Dunbar, et al., published on Mar. 6, 2015, and IETF RFC draft titled, “MPLS-Based Hierarchical SDN for hyper-Scale DC/Cloud,” by L. Fang, et al., published on Mar. 27, 2015, which are all hereby incorporated by reference as if reproduced in their entirety, or other versions thereof.

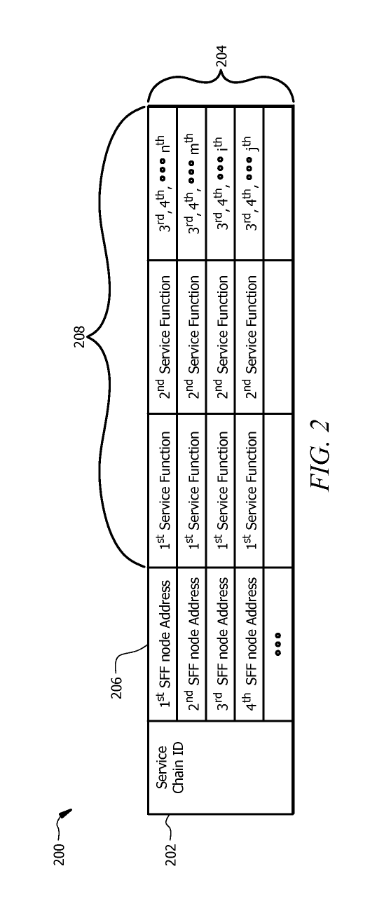

FIG. 2 is an embodiment of a service function chain 200. Service function chain 200 may be generated or obtained by an SC-PCE, for example, SC-PCE 104 in FIG. 1, to provide service function information. Service function chain 200 comprises a service chain ID 202 and one or more SFF network node entries 204 for a service function path. Service chain ID 202 identifies a service function path and may be associated with a tunnel, port, or any data packet attribute. The SFF network node entries 204 comprise a list 206 of SFF network nodes along the service function path and one or more service functions 208 that are attached to or associated with each of the SFF network nodes.

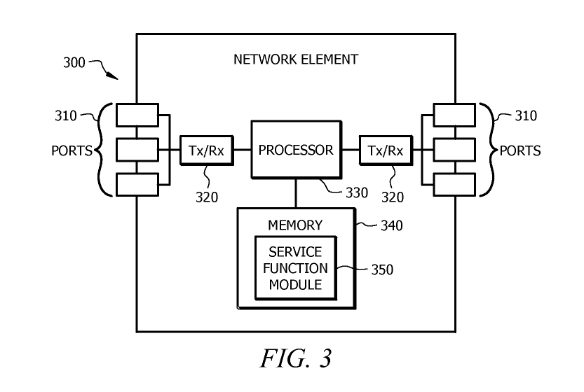

FIG. 3 is a schematic diagram of an embodiment of a network element 300. The network element 300 may be suitable for implementing the disclosed embodiments. Network element 300 may be any device (e.g., a modem, a switch, router, bridge, server, client, controller, etc.) that transports or assists with transporting data through a network, system, and/or domain. For example, network element 300 may be implemented in network nodes 106-112 in FIG. 1. Network element 300 comprises ports 310, transceiver units (Tx/Rx) 320, a processor 330, and a memory 340 comprising a service function module 350. Ports 310 are coupled to Tx/Rx 320, which may be transmitters, receivers, or combinations thereof. The Tx/Rx 320 may transmit and receive data via the ports 310. Processor 330 is configured to process data. Memory 340 is configured to store data and instructions for implementing embodiments described herein. The network element 300 may also comprise electrical-to-optical (EO) components and optical-to-electrical (OE) components coupled to the ports 310 and Tx/Rx 320 for receiving and transmitting electrical signals and optical signals.

The processor 330 may be implemented by hardware and software. The processor 330 may be implemented as one or more central processing unit (CPU) chips, logic units, cores (e.g., as a multi-core processor), field-programmable gate arrays (FPGAs), application specific integrated circuits (ASICs), and digital signal processors (DSPs). The processor 330 is in communication with the ports 310, Tx/Rx 320, and memory 340.

The memory 340 comprises one or more of disks, tape drives, and solid-state drives and may be used as an over-flow data storage device, to store programs when such programs are selected for execution, and to store instructions and data that are read during program execution. The memory 340 may be volatile and non-volatile and may be read-only memory (ROM), random-access memory (RAM), ternary content-addressable memory (TCAM), and static random-access memory (SRAM). Service function module 350 is implemented by processor 330 to execute the instructions for implementing various embodiments for routing and forwarding data packets along different service function paths and forwarding paths based on service function path information, generating service function path entries based on the service function path information, generating steering policies based on the service function path information, and generating local or internal forwarding policies. The inclusion of service function module 350 provides an improvement to the functionality of network element 300. The service function module 350 also effects a transformation of network element 300 to a different state. Alternatively, service function module 300 is implemented as instructions stored in the processor 330.

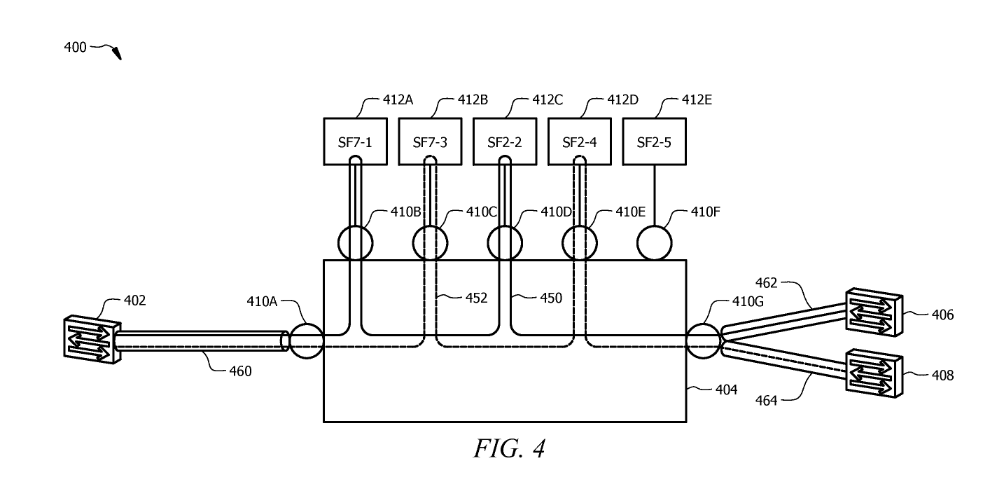

FIG. 4 is a schematic diagram of an embodiment of a portion 400 of a network implementing service function instance forwarding. The portion 400 of the network may be a portion of a network configured similarly to network 100 in FIG. 1. The portion 400 of the network comprises network nodes 402-408. The portion 400 of the network may be configured as shown or in any other suitable manner.

Network nodes 402, 406, and 408 may be configured similarly to network nodes 106-112 in FIG. 1. Network node 404 is an SFF network node comprising a plurality of ports 410A-410G and is configured similarly to network node 108 in FIG. 1. Port 410A is an ingress port and port 410G is an egress port. Ports 410B-410F are each coupled to service functions 412A-412E (shown as SFX-X), respectively. Service functions 412A-412E can be realized as virtual elements, physical network elements, and/or embedded in a physical network elements and are similar to service functions in FIG. 1. Network node 404 is configured to establish tunnels (e.g., MPLS tunnels or VxLAN tunnels) to network nodes 402, 406, and 408, to associate or to map a tunnel, a port, and/or one or more data packet attributes to a service chain ID for routing data packets, to provide service function path routing, and to implement service functions on data packets. For example, network node 404 establishes a first tunnel 460 with network node 402 at port 410A, a second tunnel 462 with network node 406 at port 410G, and a third tunnel 464 with network node 408 at port 410G.

Network node 404 is configured to receive service function path information (e.g., service function path information 150 in FIG. 1), to generate service function path entries based on the service function path information, and to generate steering policies based on the service function path information. A service function path entry comprises a service chain ID, an ingress port ID, an ingress tunnel header, an egress port ID, an egress tunnel header, and one or more local service functions. A steering policy comprises a service chain ID, an ingress port ID, an egress port ID, and an action or instruction to be implemented by the network node.

As an example, network node 404 receives service function path information for a first service path 450 between network node 402 and network node 406 and service function path information for a second service function path 452 between network node 402 and network node 408. The first service function path 450 comprises a path from network node 402 via port 410A to service function 412A via port 410B, to service function 412C via port 410D, and to network node 406 via port 410G. The second service function path 452 comprises a path from network node 402 via port 410A to service function 412B via port 410C, to service function 412D via port 410E, and to network node 408 via port 410G. Accordingly, network node 404 is configured to generate service function path entries and steering policies for the first service path 450 and the second service path 452.

Data packets can be forwarded along the first service function path 450 and the second function path 452. Data packets may comprise one or more data packet attributes that are associated with a service chain ID and can be forwarded based on the service chain ID, the tunnel and/or port where they are received, and/or based on one or more data packet attributes. For example, a data packet for the first service function path 450 is received at port 410A. The data packet is forwarded to service function 412A via port 410B. The processed data packet is received from service function 412A at port 410B and is forwarded to service function 412C via port 410D. The processed data packet is received from service function 412C at port 410D and is forwarded to network node 406 via port 410G. The data packet is forwarded to network node 406 using packet headers or tunnel headers from the service function path entries. As such, data packets are transmitted from and received at the same port to be processed by a service function.

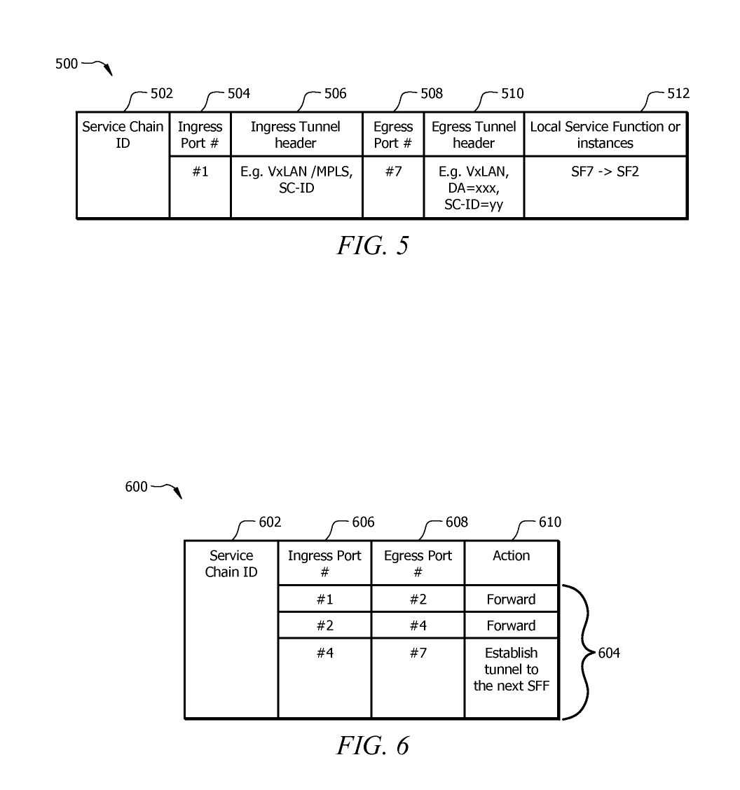

FIG. 5 is an embodiment of a service function path entry 500. Service function path entry 500 may be generated by an SFF network node, for example, network node 108 in FIG. 1 and network node 404 in FIG. 4. Service function path entry 500 is generated based on service path information, for example, service path information 150 in FIG. 1. Service function path entry 500 provides routing and forwarding information for both network nodes and service functions. Service function path entry 500 comprises a service chain ID field 502, an ingress port ID field 504, an ingress tunnel header field 506, an egress port ID field 508, an egress tunnel header field 510, and a local service functions field 512. Service chain ID field 502 identifies a service chain ID associated with a service function path. Ingress port ID field 504 identifies an ingress port for the service function path. Ingress tunnel header field 506 comprises a header for a tunnel that is attached to the ingress port. A header may comprise a VxLAN header, an MPLS header, a service chain identifier (SC-ID), a source address, a destination address, or any other suitable routing information. Egress port ID field 508 identifies an egress port for the service function path. Egress tunnel header field 510 comprises a header for a tunnel that is attached to the egress port. Local service functions field 512 identifies one or more local service function for the service function path.

FIG. 6 is an embodiment of a steering policy 600 for forwarding or steering data packets along a service function path. Steering policy 600 may be generated by an SFF network node, for example, network node 108 in FIG. 1 and network node 404 in FIG. 4. Steering policy 600 is generated based on service path information, for example, service path information 150 in FIG. 1. Steering policy 600 comprises a service chain ID 602 and steering policy entries 604. Steering policy entries 604 comprises a series of ingress port ID fields 606, egress port ID fields 608, and action fields 610 to be implemented by a network node to forward or steer a data packet along a service function path. Service chain ID field 602 identifies a service chain ID associated with a service function path. Ingress port ID field 606 identifies an ingress port for at least a portion of the service function path. Egress port ID field 608 identifies an egress port for at least a portion of the service function path. Action field 610 identifies an action to be implemented by the network node. Examples of actions include, but are not limited to, forwarding and establishing a tunnel to another network node.

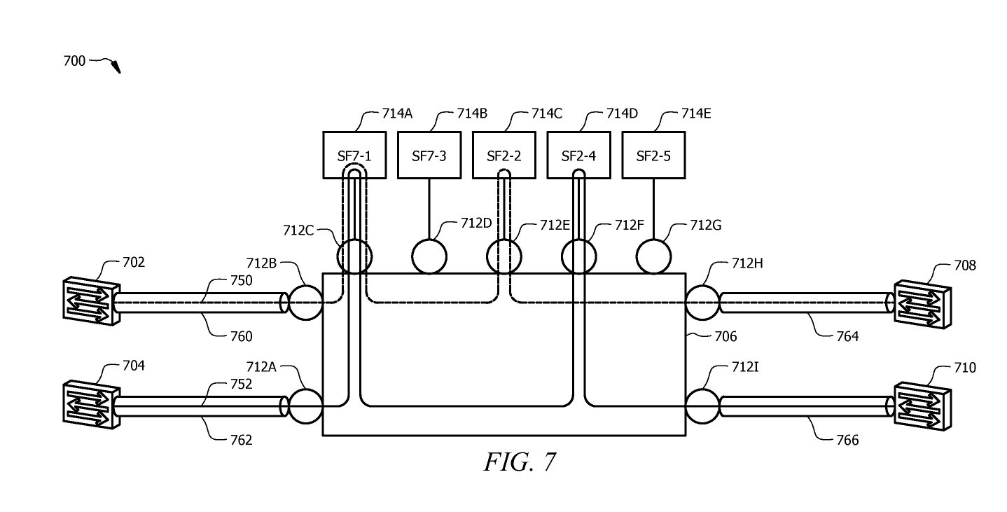

FIG. 7 is a schematic diagram of an embodiment of a portion 700 of a network implementing service function forwarding across multiple network layers, for example, OSI data link layer 2 and network layer 3. When implementing service function forwarding across multiple network layers, a service chain ID may be removed from a data packet before sending the data packet to a service function. The portion 700 of the network may be a portion of a network configured similarly to network 100 in FIG. 1. The portion 700 of the network comprises network nodes 702-710. The portion 700 of the network may be configured as shown or in any other suitable manner.

Network nodes 702, 704, 708, and 710 may be configured similarly to network nodes 106-112 in FIG. 1. Network node 706 is an SFF network node comprising a plurality of ports 712A-712I and is configured similarly to network node 108 in FIG. 1. Ports 712A and 712B are ingress ports and ports 712H and 712I are egress ports. Ports 712C-712G are each coupled to service functions 714A-714E (shown as SFX-X), respectively. Service functions 712A-712E can be realized as virtual elements, physical network elements, and/or embedded in a physical network elements and are similar to service functions in FIG. 1. Network node 706 is configured to establish tunnels to network nodes 702, 704, 708, and 710, to provide service function path routing, and to implement service functions on data packets. For example, network node 706 establishes a first tunnel 760 with network node 702 at port 712B, a second tunnel 762 with network node 704 at port 712A, a third tunnel 764 with network node 708 at port 712H, and a fourth tunnel 766 with network node 710 at port 712I.

Network node 706 is configured to receive service function path information (e.g., service function path information 150 in FIG. 1), to associate or to map a tunnel, a port, and/or one or more data packet attributes to a service chain ID for routing data packets, to generate service function path entries based on the service function path information, to generate steering policies based on the service function path information, and to generate local or internal forwarding policies. Service function path entries may be similar to service function path entries 500 in FIG. 5 and steering policies may be similar to steering policy 600 in FIG. 6. Steering policies may also be configured to use port IDs and local labels. Local labels may be generated and assigned by network node 706 to route a data packet to one or more local service functions that are attached to network node 706. For example, a local label is a local virtual local access network (VLAN) label that corresponds with a service chain ID and a tunnel or port for a service function. Local label are recognizable by service functions. Local forwarding policies may be employed to route data packets within a network node using port ID and/or local labels. Examples of local labels include, but are not limited to, VLAN IDs, global unique identifiers (GUIDs), user defined labels, and Ethernet headers.

As an example, network node 706 receives service function path information for a first service function path 750 between network node 702 and network node 708 and service function path information for a second service function path 752 between network node 704 and network node 710. The first service function path 750 uses layer 2 routing and comprises a path from network node 702 via port 712B to service function 714A via port 712C, to service function 714C via port 712E, and to network node 708 via port 712H. The second service function path 752 uses layer 3 routing and comprises a path from network node 704 via port 712A to service function 714A via port 712C, to service function 714D via port 712F, and to network node 710 via port 712I. Accordingly, network node 706 is configured to generate service function path entries and steering policies for the first service path 750 and the second service path 752.

Data packets may comprise one or more data packet attributes that are associated with a service chain ID and can be forwarded based on the service chain ID, the tunnel and/or port where they are received, and/or the one or more data packet attributes. When a data packet is received for the first service function path at port 712B, the data packet is forwarded to service function 714A via port 712C. The processed data packet is received from service function 714A at port 712C and is forwarded to service function 714C via port 712E. The processed data packet is received from service function 714C at port 712F and is forwarded to network node 708 via port 712H. The data packet is forwarded to network node 708 using tunnel headers from the service function path entries.

When a data packet is received for the second service function at port 712A, the packet header or tunnel header is removed from the data packet and a local label is added to the data packet. The data packet is forwarded to service function 714A via port 712C. The processed data packet is received from service function 714A at port 712C and is forwarded to service function 714D via port 712F. In an embodiment, a second local label is attached to the processed data packet before sending the data packet to service function 714D. The processed data packet is received from service function 714D at port 712F and is forwarded to network node 710 via port 712I. The data packet is forwarded to network node 710 using a packet header or a tunnel header from the service function path entries. In an embodiment, the data packet is forwarded to network node 710 with local labels. Alternatively, the local labels are removed and the packet header or tunnel header is added to the data packet before sending the data packet to network node 710.

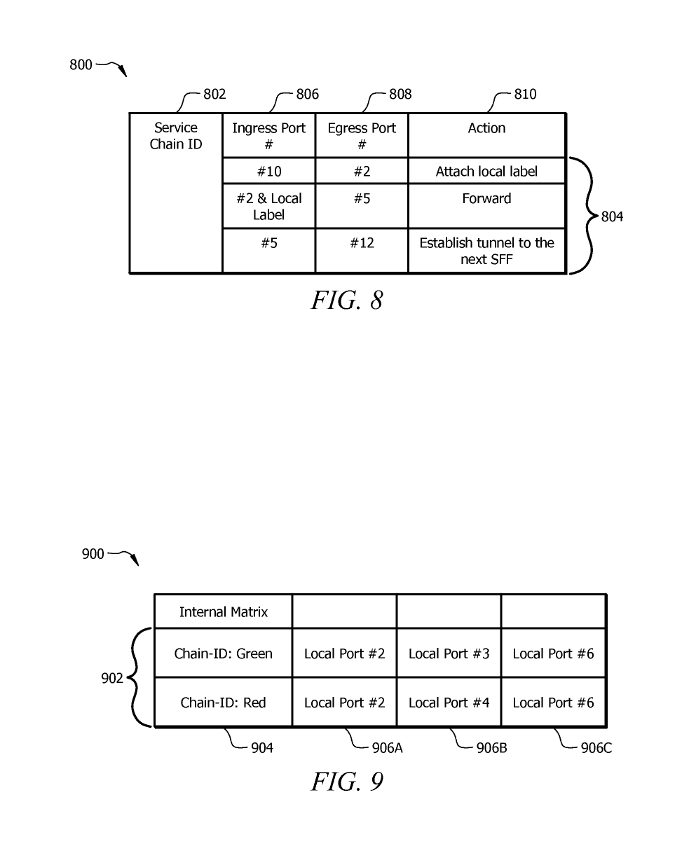

FIG. 8 is an embodiment of a steering policy 800 for forwarding or steering data packets along a service function path and across multiple network layers. Steering policy 800 may be generated by an SFF network node, for example, network node 108 in FIG. 1 and network node 404 in FIG. 4. Steering policy 800 is generated based on service path information, for example, service path information 150 in FIG. 1. Steering policy 800 comprises a service chain ID 802 and steering policy entries 804. Steering policy entries 804 comprises a series of ingress port ID fields 806, egress port ID fields 808, and action fields 810 to be implemented by a network node to forward or steer a data packet along a service function path. Service chain ID field 802, ingress port ID field 806, egress port ID field 808, and action field 810 are configured similarly to service chain ID field 602, ingress port ID field 606, egress port ID field 608, and action field 610 in FIG. 6, respectively. Further, ingress port ID field 806 and/or egress port ID field 808 may use local labels to identify and route to/from ports and service functions.

FIG. 9 is an embodiment of a local forwarding policy 900 for routing data packets within a network node (e.g., network node 706 in FIG. 7) using port ID and/or local labels. Local forwarding policy 900 may be generated by an SFF network node, for example, network node 108 in FIG. 1 and network node 404 in FIG. 4. Local forwarding policy 900 is generated based on service path information, for example, service path information 150 in FIG. 1. Local forwarding policy 900 comprises forwarding entries 902. Forwarding entries 902 comprise a service chain ID field 904 and port ID fields 906A-906C. The service chain ID field 904 identifies a service ID associated with a service function path. Port ID fields 906A-906C identify a series of ports and/or service functions for a data packet to traverse along a service path within the network node. Ports and/or service functions are identified using port IDs and local labels. For example, port ID fields 906A-906C may cumulative define a path from an ingress port to a service function port and from the service function port to an egress port. Forwarding entries 902 may comprise any number of port ID fields 906A-906C. Local forwarding policy 900 may be configured as shown or in any suitable manner.

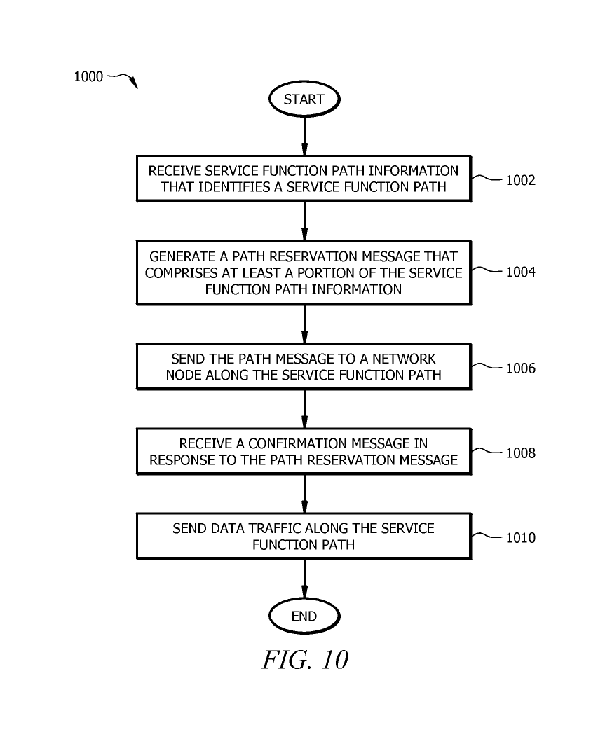

FIG. 10 is a flowchart of an embodiment of a service function instance forwarding method 1000. Method 1000 is implemented by a network node to route and forward a data packet along a service function path. For example, the network node may be configured similarly to network node 106 in FIG. 1. At step 1002, the network node receives service function path information that identifies a service function path from an SC-PCE (e.g., SC-PCE 104 in FIG. 1). The service path information is similar to service path information 150 in FIG. 1. The network node uses the service path information to generate service function path entries, steering policies, and/or local forwarding policies. Service function path entries are similar to service function path entries 500 in FIG. 5. Steering policies are similar to steering policy 600 in FIG. 6 and steering policy 800 in FIG. 8. Local forwarding policies are similar to local forwarding policy 900 in FIG. 9. At step 1004, the network node generates a path reservation message that comprises at least a portion of the service function path information. The path reservation message is similar to path message 152 in FIG. 1. Alternatively, the network node generates a data packet or message that is suitable for carrying at least a portion of the service function path information. At step 1006, the network node sends the path reservation message to a next-hop network node along the service function path. The network node may also establish a tunnel to the next hop along the service function path before sending the path reservation message. The tunnel may be established using any suitable protocol as would be appreciated by one of ordinary skill in the art upon viewing this disclosure. At step 1008, the network node receives a confirmation message in response to the path reservation message for the service function path from network nodes along the service function path. The confirmation message is similar to confirmation message 154 in FIG. 1. At step 1010, the network node sends data packets and data traffic along the service function path. For example, data packets are forwarded along the service function path using the service function path entries, the steering policies, and/or the local forwarding policies.

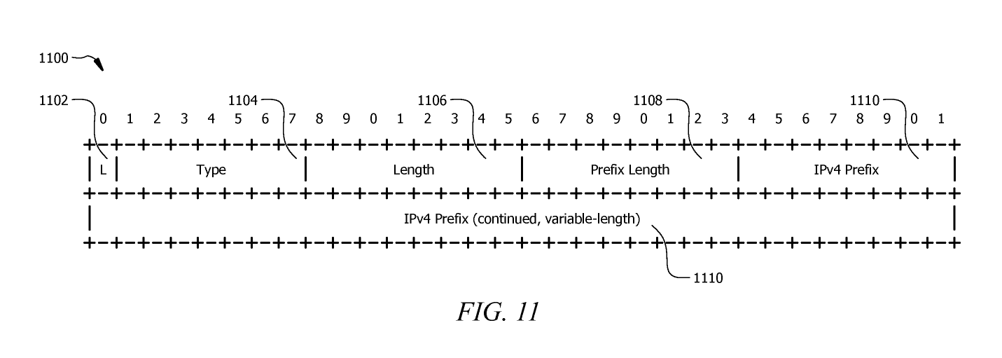

FIG. 11 is a schematic diagram of an embodiment of service function ERO sub-type-length-value (TLV) 1100. Service function ERO sub-TLV 1100 may be implemented in a path request message and indicates the service functions that are attached to or associated with each network node. Service function ERO sub-TLV 1100 may be implemented as an extension to existing MPLS EROs. Service function ERO sub-TLV 1100 may be implemented in Internet Protocol version 4 (IPv4) and Internet Protocol version 6 (IPv6). Service function ERO sub-TLV 1100 comprises a flag field 1102, a type field 1104, a length field 1106, a prefix length field 1108, and an IP prefix field 1110. Service function ERO sub-TLV 1100 may be configured as shown or in any other suitable manner.

The flag bit field 1102 is a one bit field. The type field 1104 is a seven bit field and indicates that the IP address in the service function ERO sub-TLV 1100 are associated with one or more service functions in a network node. The length field 1106 is an eight bit field and indicates the length of the service function ERO sub-TLV 1100, for example, in bytes. The prefix length field 1108 is an eight bit field and indicates the length of the IP prefix of the service function ERO sub-TLV 1100, for example, in bytes. The IP prefix field 1110 may have a variable length and comprises the IP prefix for network nodes that are attached to one or more service functions.

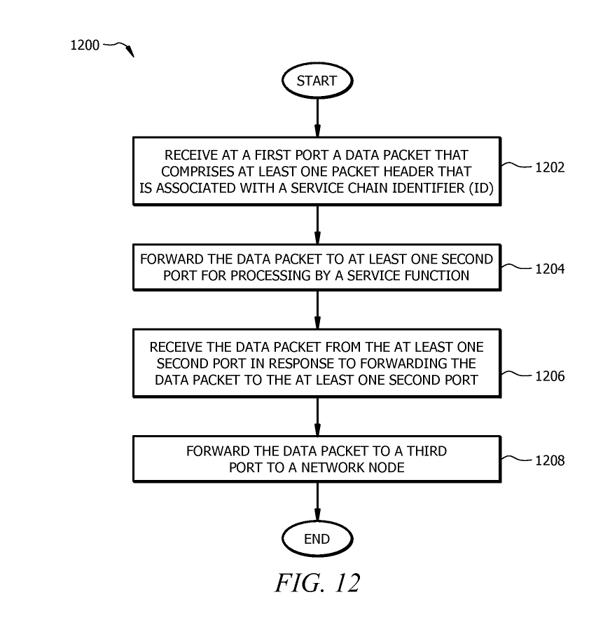

FIG. 12 is a flowchart of another embodiment of a service function instance forwarding method 1200. Method 1200 is implemented by a network node to route and forward a data packet along a service function path. For example, the network node may be configured similarly to network node 108 in FIG. 1, network node 404 in FIG. 4, and network node 706 in FIG. 7. At step 1202, the network node receives at a first port a data packet that comprises at least one packet header that is associated with a service chain ID. For instance, the first port may be ingress port 410A in FIG. 4 or ingress ports 712A and 712B in FIG. 7. The network node receives service function path information, establishes tunnels to other network nodes, associates a tunnel, a port, and/or one or more data packet attributes to the service chain ID for routing data packets, and generates service function path entries, steering policies, and local forwarding policies for routing data packets. Service function path entries are similar to service function path entries 500 in FIG. 5. Steering policies are similar to steering policy 600 in FIG. 6 and steering policy 800 in FIG. 8. Local forwarding policies are similar to local forwarding policy 900 in FIG. 9. The network node then receives data packets along a service function associated with the service path information. At step 1204, the network node forwards the data packet to at least one second port for processing by a service function using the service function path entries, steering policies, and local forwarding policies. For example, the at least one second port may be ports 410B-410F in FIG. 4 or ports 712C-712G in FIG. 7. At step 1206, the network node receives the processed data packet from the at least one second port in response to forwarding the data packet to the at least one second port. For example, the service function is configured to receive the data packet from a second port of the network node, to process the data packet, and to return the processed data packet to the second port of the network node. Steps 1204 and 1206 may be repeated one or more times to forward the data packet to other service functions. At step 1208, the network node forwards the data packet to a third port to a second network node using service function path entries, steering policies, and local forwarding policies. For instance, the third port may be egress port 410G in FIG. 4 or egress ports 712H and 712I in FIG. 7.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A data packet forwarding method comprising:
receiving at a first port a data packet that comprises at least one packet header that is associated with a service chain identifier (ID);
forwarding the data packet to at least one second port for processing by at least one service function;
receiving the data packet from the at least one second port in response to forwarding the data packet to the at least one second port; and
forwarding the data packet to a third port to a network node.

2. The method of claim 1, wherein forwarding the data packet to the at least one second port is based on the service chain ID.

3. The method of claim 1, wherein forwarding the data packet to the at least one second port comprises routing the data packet based on the service chain ID and the first port.

4. The method of claim 1, wherein forwarding the data packet to the at least one second port comprises routing the data packet based on the service chain ID, the at least one field in packet header, or both.

5. The method of claim 1, further comprising:
attaching a first local label to the data packet that is recognized by a first service function from the at least one service function; and
forwarding the data packet to the at least one second port for processing by the first service function.

6. The method of claim 5, wherein forwarding the data packet to the at least one second port comprises routing the data packet based on the service chain ID and the first local label.

7. The method of claim 5, further comprising attaching a second header to the data packet before forwarding the data packet to the network node.

8. The method of claim 5, further comprising:
receiving the data packet from the first service function;
attaching a second local label to the data packet that is recognized by a second service function from the at least one service function; and
forwarding the data packet to the at least one second port for processing by the second service function.

9. A data packet routing method comprising:
receiving service function path information that identifies a service function path;
generating a path reservation message that comprises at least a portion of the service function path information;
sending the path reservation message to a network node along the service function path; and
receiving a confirmation message in response to the path reservation message.

10. The method of claim 9, wherein the service path information comprises a service chain identifier (ID) corresponding to the service function path, and wherein the service path information identifies at least one network node along the service function path and at least one service function associated with the at least one network node.

11. The method of claim 9, further comprising generating a steering policy based on the service function path information, wherein the steering policy identifies an ingress port, an egress port, and an action based on the ingress port and the egress port.

12. The method of claim 9, further comprising generating a service function path entry, wherein the service function path entry identifies an ingress port to a first network node, one or more ports, one or more service functions that are associated with the one or more ports, and an egress port to a second network node.

13. The method of claim 9, further comprising generating a local forwarding policy, wherein the local forwarding policy identifies a service chain identifier (ID) for the service function path and at least one port that is associated with a service function.

14. An apparatus comprising:
an ingress port;
an egress port;
a port associated with a service function;
a memory; and
a processor coupled to the ingress port, the egress port, the port, and the memory, and configured to:
receive from the ingress port a data packet that comprises a packet header that is associated with a service chain identifier (ID);
forward the data packet to the port for processing by the service function;
receive the data packet from the port in response to forwarding the data packet to the port; and
forward the data packet to the egress port to a network node.

15. The apparatus of claim 14, wherein the processor is configured to forward the data packet to the port based on the service chain ID.

16. The apparatus of claim 14, wherein the processor is configured to forward the data packet to the port by routing the data packet based on the service chain ID and the port.

17. The apparatus of claim 14, wherein the processor is configured to forward the data packet to the port by routing the data packet based on the service chain ID and an ingress tunnel header.

18. The apparatus of claim 14, wherein the processor is configured to:
attach a local label to the data packet that is recognized by the service function; and
forwarding the data packet to the port for processing by the service function.

19. The apparatus of claim 18, wherein the processor is configured to forward the data packet to the port by routing the data packet based on the service chain ID and the local label.

20. The apparatus of claim 14, wherein the processor is configured to attach a second header to the data packet before forwarding the data packet to the network node.
